(19) United States
(12) Patent Application Publication
(10) Pub. No.: US 2007/0076040 A1
(43) Pub. Date: Apr. 5, 2007

(54) Methods and apparatus for inkjet nozzle calibration

(75) Inventors: Quanyuan Shang, Saratoga, CA (US); Fan-Cheung Sze, San Jose, CA (US)

Correspondence Address: DUGAN & DUGAN, PC, 55 SOUTH BROADWAY, TARRYTOWN, NY, 10591, US

(73) Assignee: Applied Materials, Inc., Santa Clara, CA (US)

(21) Appl. No.: 11/489,258

(22) Filed: Jul. 19, 2006

Related U.S. Application Data
(60) Provisional application No. 60/721,741, filed on Sep. 29, 2005.

(51) Int. Cl. B41J 29/393

(52) U.S. Cl. 347/19

(57) ABSTRACT

Methods and apparatus are provided for calibrating inkjet print nozzles that include dispensing a plurality of ink drops onto a surface with one or more inkjet print nozzles at a firing pulse voltage, measuring a parameter of the ink drops, and calibrating the firing pulse voltage of at least one of the one or more inkjet print nozzles based on the measured parameter of the ink drops.

### CROSS REFERENCE TO RELATED APPLICATIONS

The present application is related to U.S. patent application Ser. No. 11/019,930, filed Dec. 22, 2004 and entitled “METHODS AND APPARATUS FOR ALIGNING PRINT HEADS” which is hereby incorporated by reference herein in its entirety.

The present application is related to U.S. Provisional Patent Application Ser. No. 60/721,741, filed Sep. 29, 2005 and entitled “METHODS AND APPARATUS FOR INKJET PRINTING COLOR FILTERS FOR DISPLAY PANELS” which is hereby incorporated by reference herein in its entirety.

The present application is related to U.S. patent application Ser. No. 11/123,502, filed May 4, 2005 and entitled “DROPLET VISUALIZATION OF INKJETTING” which is hereby incorporated by reference herein in its entirety.

The present application is related to U.S. patent application Ser. No. 11/061,148, filed on Feb. 18, 2005 and entitled “INKJET DATA GENERATOR” which is hereby incorporated by reference herein in its entirety.

The present application is related to U.S. patent application Ser. No. 11/061,120, filed on Feb. 18, 2005 and entitled “METHODS AND APPARATUS FOR PRECISION CONTROL OF PRINT HEAD ASSEMBLIES” which is hereby incorporated by reference herein in its entirety.

The present application is related to U.S. patent application Ser. No. 11/238,637, filed on Sep. 29, 2005 and entitled “METHODS AND APPARATUS FOR A HIGH RESOLUTION INKJET FIRE PULSE GENERATOR” which is hereby incorporated by reference herein in its entirety.

### FIELD OF THE INVENTION

The present invention relates generally to systems and methods for printing color filters for flat panel displays, and is more particularly concerned with systems and methods for calibrating inkjet fire pulses.

### BACKGROUND OF THE INVENTION

The flat panel display industry has been attempting to employ inkjet printing to manufacture display devices, in particular, color filters. Due to manufacturing variations and other factors, inkjet nozzles may not dispense identically sized drops for a given firing pulse voltage. Accordingly, methods and apparatus are needed to calibrate and adjust inkjet nozzles.

### SUMMARY OF THE INVENTION

In certain aspects, the present invention provides a method of calibrating inkjet print nozzles including dispensing a plurality of ink drops onto a surface with one or more inkjet print nozzles at a firing pulse voltage, measuring a parameter of the ink drops, and calibrating the firing pulse voltage of at least one of the one or more inkjet print nozzles based on the measured parameter of the ink drops.

In other aspects, the present invention provides a system for calibrating an inkjet print nozzle including one or more inkjet print nozzles, the inkjet print nozzles adapted to dispense ink drops in response to a firing pulse voltage, an imaging system adapted to measure a parameter of the dispensed ink drops, and a controller adapted to correlate the measured parameter of the dispensed ink drops with the firing pulse voltage and pass a signal indicative of the firing pulse voltage to the inkjet print nozzles so as to cause the nozzles to dispense ink drops with substantially the expected value of the measured parameter.

In yet other aspects, the present invention provides an apparatus for calibrating an inkjet printing system having logic including a processor, a memory coupled to the logic, and a fire pulse generator circuit coupled to the logic and including a connector to facilitate coupling to a inkjet print nozzle. The logic is adapted to receive ink drop measurement data and to convert the ink drop measurement data to an ink drop measurement data file adapted to be used to trigger the inkjet print nozzle to deposit ink into pixel wells on a substrate with a firing pulse voltage.

Other features and aspects of the present invention will become more fully apparent from the following detailed description, the appended claims and the accompanying drawings.

### BRIEF DESCRIPTION OF THE DRAWINGS

FIG. 1A is a front perspective view of an inkjet printing system according to some aspects of the present invention.

FIG. 1B is a close-up schematic view of a portion of an inkjet printing system according to some aspects of the present invention.

FIG. 2 is a cross sectional perspective view of a substrate printed with ink drops according to some aspects of the invention.

FIG. 3 illustrates an embodiment of a fire pulse database provided in tabular format.

FIG. 4 is a flowchart depicting an exemplary method of embodiments of the present invention.

### DETAILED DESCRIPTION

Inkjet printers frequently make use of one or more inkjet print heads mounted within one or more carriages under which a substrate, such as glass, is moved back and forth to print a color filter for a flat panel display. As the substrate travels relative to the heads, an inkjet printer control system activates individual nozzles within the heads to deposit or eject ink (or other fluid) droplets onto the substrate to form images.

Activating a nozzle may include sending a fire pulse signal or firing pulse voltage (V_{fp}) to the individual nozzle to cause an ejection mechanism to dispense a quantity of ink. In some heads, the pulse voltage is used to trigger, for example, a piezoelectric element that pushes ink out of the nozzle. In other heads the pulse voltage causes a laser to irradiate a membrane that, in response to the laser light, pushes ink out of the nozzle. Other methods may be employed.

Due to manufacturing variations and/or other factors, nozzles may not dispense drops of equal volume for a given firing pulse voltage. In some cases, the volume of ink drops may vary non-linearly with V_{fp}.

The present invention provides systems and methods for determining ink drop size. The present invention further provides a method of determining the relationship between ink drop size and V_{fp} and using this relationship to calibrate inkjet nozzles. Specifically, a line of ink drops may be dispensed with a known V_{fp} on a flat glass with no black matrix. The relative height and/or width of the ink on the flat glass may be measured. This-information may be used to calibrate each nozzle such that a consistent height and/or width may be achieved. In an alternative embodiment, ink may be dispensed into black matrix pixel wells with a known V_{fp}. The depth of ink deposited in each pixel well may then be measured to determine a volume of ink dispensed by each nozzle. This volume information may be used to calibrate each nozzle such that a consistent height, width, and/or drop size may be achieved.

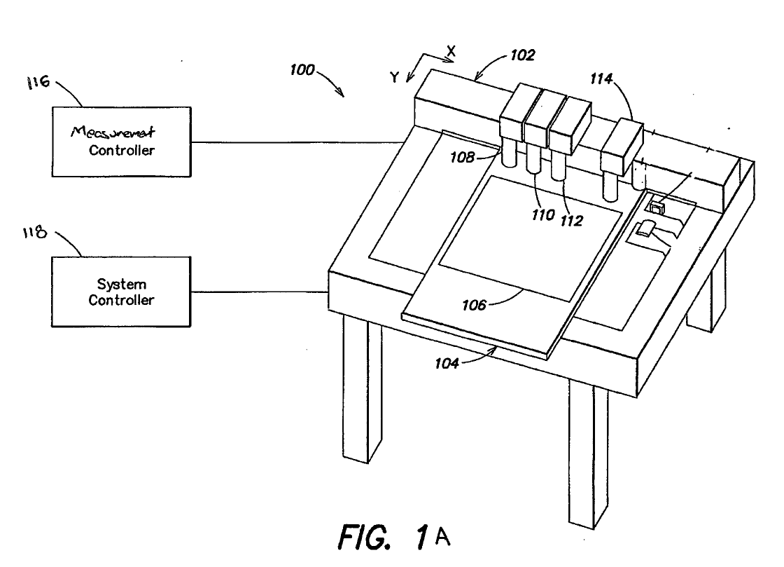

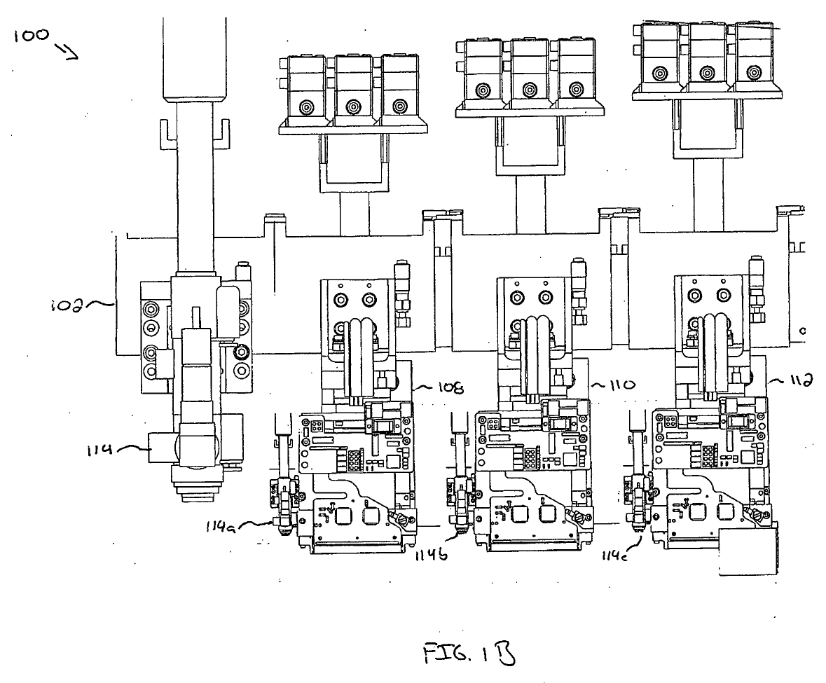

FIGS. 1A and 1B illustrate a front perspective view and a close-up schematic view, respectively, of an embodiment of an inkjet printing system of the present invention which is designated generally by reference numeral 100. In FIG. 1A, the inkjet printing system 100 of the present invention, in an exemplary embodiment, may include a print bridge 102. The print bridge 102 may be positioned above and/or coupled to a stage 104. The stage 104 may support a substrate 106.

Supported on print bridge 102 may be print heads 108, 110, 112. Print bridge 102 may also support a measurement device 114. Measurement device 114 may be coupled (e.g., logically and/or electrically) to measurement device controller 116. Similarly, print heads 108-112 and print bridge 102 may be coupled (e.g., logically and/or electrically) to a system controller 118.

In the exemplary embodiment of FIG. 1A, the print bridge 102 may be supported above the stage 104 in such a manner as to facilitate inkjet printing. The print bridge 102 and/or stage 104 may be movable each independently in both the positive and negative X- and Y-directions as indicated by the X- and Y-direction arrows in FIG. 1A. In the same or alternative embodiments print bridge 102 and stage 104 may be rotatable. The print bridge 102 may be capable of supporting and moving any number of print heads 108-112 and/or sensors (e.g., measurement device 114). The substrate 106 may sit atop or, in some embodiments, be coupled to the movable stage 104.

Although three print heads 108-112 are shown on print bridge 102 in FIG. 1A, it is important to note that any number of print heads may be mounted on and/or used in connection with the print bridge 102 (e.g., 1, 2, 4, 5, 6, 7, etc. print heads). Print heads 108-112 may each be capable of dispensing a single color of ink or, in some embodiments, may be capable of dispensing multiple colors of ink. Inkjet print heads 108-112 may be movable and/or alignable vertically, horizontally and/or rotationally so as to enable accurate inkjet drop placement. The print bridge 102 may also be movable and/or rotatable to position print heads 108-112 for accurate inkjet printing. In operation, the inkjet print heads 108-112 may dispense ink (e.g., from a nozzle) in drops.

Measurement device 114 may be directed toward the substrate 106 and may be capable of capturing still and/or moving images of the substrate 106. Measurement device 114 may also be a laser height sensor or the like. Exemplary measurement devices for use in an inkjet printing system are described in previously incorporated U.S. patent application Ser. No. 11/019,930. Similarly, measurement device 114 may include one or more high resolution digital line scan cameras, CCD-based cameras, and/or any other suitable cameras. Exemplary measurement devices for use in an inkjet print system are also described in previously incorporated Attorney Docket No. 10465. In this example, a laser sensor may be utilized. The laser sensor may, at a high sampling rate and accuracy, measure the thickness and/or height of the dispensed ink drops. An example of a commercially available laser sensor is the LC-series Laser Displacement Meter manufactured by Keyence Corp. of Osaka, Japan. Another example of a commercially available sensor is the Omron ZS series manufactured by Omron Electronics Pte Ltd of Singapore. Other numbers and/or types of measurement devices may be used.

In an exemplary embodiment, the measurement device 114 may be coupled to the print bridge 102 in a position and manner similar to that used for a print head. That is, the measurement device 114 may be capable of similar rotation and movement as the print heads 108-112 and may be moved adjacent the print heads 108-112 or may be spaced apart from them. The measurement device 114 may include a single camera or, in some embodiments, multiple cameras (e.g., 2, 3, etc.) in a cluster. Measurement device 114 may be positioned on either side of the print heads 108-112 or may be positioned interstitially. Measurement device 114 may be angled to capture images of a completed print pass (e.g., to capture images of ink drops on substrate 106) or may be angled in any direction to capture images of various portions of the substrate 106. In some embodiments, measurement device 114 may include multiple measurement devices, which may be of the same or different types (e.g., a CCD camera and a laser height sensor).

In some embodiments, measurement device 114 may be capable of capturing images of the substrate 106 and/or ink drops released from print heads 108-112. Measurement device 114 is preferably capable of capturing images of sufficient quality to discern ink drops of about 2 um to about 100 um in diameter. Accordingly, measurement device 114 may include a telescope zoom lens and may have high resolution (e.g., at least about 1024×768 pixels). The measurement device 114 may also be equipped with motorized zoom and/or focus features.

Measurement device controller 116 may be capable of processing measurement information received from the measurement device 114. The measurement device controller 116 may also be capable of transmitting command and control information to these same devices. Measurement device controller 116 may be any suitable computer or computer system, including, but not limited to, a mainframe computer, a minicomputer, a network computer, a personal computer, and/or any suitable processing device, component, or system. Likewise, the measurement device controller 116 may comprise a dedicated hardware circuit or any suitable combination of hardware and software.

Similarly, the print bridge 102, stage 104, and/or inkjet print heads 108-112 may be coupled to system controller 126. System controller 118 may be adapted to control motion of the print bridge 102, the stage 104, and/or the inkjet print heads 108-112 in inkjet printing operations. System controller 118 may also control firing pulse signals for inkjet print heads 108-112. In at least one embodiment, the measurement device controller 116 and the system controller 118 may comprise a single controller or multiple controllers.

FIG. 1B depicts a close-up view of a portion of the inkjet printing system 100. Inkjet printing system 100 may include print heads 108-112 mounted on print bridge 102. Also mounted on print bridge 108 may be measurement device 114. Measurement device may similarly be located in alternate measurement device locations, such as adjacent print heads 108-112, as illustrated by measurement devices 114a-c. Measurement devices 114 may be movable, rotatable, and angleable in such ways as to allow the system to view a current or prior printing pass. In an alternative embodiment, measurement devices 114 may be mountable in the same mount as any of print heads 108-112 or to the print heads 108-112 themselves and may be similarly movable, rotatable, and angleable. Further exemplary measurement devices for use in an inkjet printing system are described in U.S. patent application Ser. No. 11/019,930, filed Dec. 22, 2004 and entitled “METHODS AND APPARATUS FOR ALIGNING PRINT HEADS” which is hereby incorporated by reference herein in its entirety. Similarly, measurement devices 114 may include one or more high resolution digital line scan cameras, CCD-based cameras, and/or any other suitable cameras. An exemplary measurement device for use in the present invention may incorporate an objective lens capable of multiple times zoom with approximately 8000 pixels and a 5 um pixel resolution. The exemplary measurement device may also have a 100 KHz line rate and may be capable of scanning the substrate at 500 mm/second. Cameras having other characteristics may also be used.

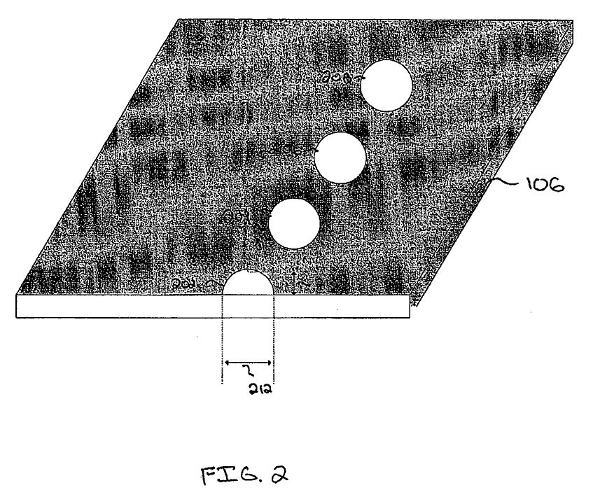

FIG. 2 depicts a cross-sectional magnified perspective view of a substrate upon which the system 100 of FIG. 1 may print. Substrate 106 may be printed with (e.g., have ink drops deposited thereon by print heads 108-112) a line of ink drops 202, 204, 206, 208. Each ink drop 202-208 may have a measurable height 210 and width 212. The height 210 may be an average, maximum, or minimum height as appropriate. In some embodiments, the height 210 may be a depth of ink deposited in a pixel well. Similarly, the width 212 may be a diameter, a maximum, a minimum, or an average width as appropriate.

The size of ink drops 202-208 may be expressed in terms of actual units of volume (e.g., picoliters) or drop size may merely be indicated in relative terms (e.g., drop size may be specified merely using “small,” “medium,” or “large”).

The substrate 106 may be a flat glass with no black matrix or may be a substrate with black matrix pixel wells into which ink may be deposited (e.g., printed, dispensed). A calibration substrate may be used in some embodiments or the calibration methods described herein may be used during a normal printing operation.

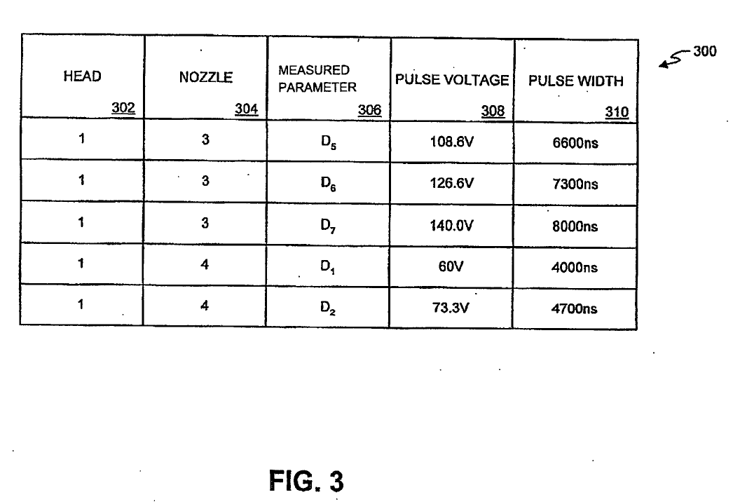

Turning to FIG. 3, an example embodiment of a fire pulse database 300 is provided in tabular format. A fire pulse database 300 according to some embodiments of the present invention may be used to store the required pulse voltage necessary to dispense a desired drop size from a particular nozzle (for each drop size from each nozzle of each head). Thus, for a system controller 118 that uses N bits of pixel data, a fire pulse database 300 would include
(2^{N}−1)*(number of nozzles)*(number of heads)
entries where the (2^{N}−1) term represents the number of drop sizes. The particular example database 300 of FIG. 3 only depicts five sample entries, but in a three head, 128 nozzles per head, and N=3 print head control system 100, such a database 300 would include 2,688 entries [(2³−1)*128*3=2,688].

The particular representation of a fire pulse database 300 depicted in FIG. 3 includes five fields for each of the entries or records. The fields may include: (i) a print head identification field 302 that stores a representation uniquely identifying the relevant print head, (ii) a nozzle identification field 304 that stores a representation uniquely identifying the relevant nozzle of the specified head 302, (iii) a measured parameter field 306 that stores a representation uniquely identifying the measured drop size for the specified nozzle 304 on the specified head 302, (iv) a pulse voltage field 308 that stores a representation of the amplitude of a firing pulse signal required to cause the specified nozzle 304 on the specified head 302 to dispense the specified measured parameter 306, and (v) an optional pulse width field 310 that may store a representation of the width of a firing pulse signal required to cause the specified nozzle 304 on the specified head 302 to dispense the specified measured parameter 306. In some embodiments, the pulse width 310 may be held constant.

In additional and/or alternative embodiments, the pulse width 310 may be varied to provide an additional means to more accurately control adjustments to drop size. In other words, pulse width 310 may be used to fine tune a nozzle's output to more accurately and reliably dispense a particular drop size. As with pulse voltage 308 (amplitude), the precise effect of varying pulse width 310 may be experimentally determined or, in some embodiments, it may be specified by a print head manufacturer or an equation derived based upon print head characteristics. In embodiments where the pulse voltage 308 is held constant, the pulse width 310 may be the exclusive parameter used to control drop size.

The example values depicted in FIG. 3 are merely illustrative of how pulse width 310 may be varied along with pulse voltage 308 to generate a desired drop size. However, as indicated above, in some embodiments, it may not be necessary at all to vary pulse width 310. In embodiments where pulse width is varied, the pulse width may be range between a few microseconds and tens of microseconds, preferably in a range of from about seven microseconds to about twelve microseconds. The optimal firing pulse voltage may vary based on characteristics of the ink presently in use. Since variations in formulations of the ink may be common, firing pulse width may need calibration or adjustment frequently. In some embodiments, the optimal firing pulse width for a given ink formulation may be known and applied appropriately in the look-up table or other correlation method.

Other print parameters may be adjusted similarly. For example, in some embodiments pulse wave form may be adjusted similarly to the adjustments of pulse voltage and pulse width described above. Any other appropriate calibrations and adjustments may be made in accordance with the methods described below.

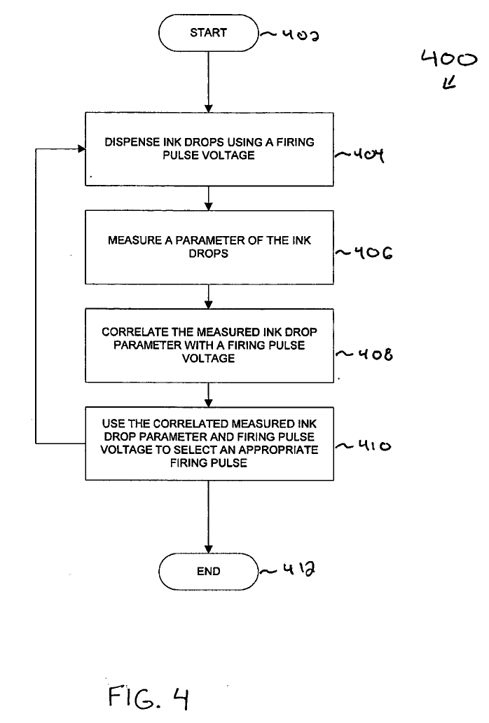

Turning to FIG. 4, a flowchart illustrating an exemplary embodiment of a calibration method 400 is provided. It should be understood that the particular arrangement of elements in the flow chart of FIG. 4, as well as the number and order of example steps of various methods discussed herein, is not meant to imply a fixed order, sequence, quantity, and/or timing to the steps; embodiments of the present invention can be practiced in any order, sequence, and/or timing that is practicable.

Referring to FIGS. 1-4, a method 400 of calibrating fire pulse voltage to dispense ink drops begins at Step 402.

In step 404, a line of ink drops, such as ink drops 202-208, are dispensed onto a substrate 106 via one or more nozzles of print heads 108-112. The ink drops may be dispensed at a known firing pulse voltage and/or pulse width. Any number of ink drops may be deposited at any number of firing pulse voltages and/or widths.

In step 406, one or more parameters of the dispensed ink drops 202-208 may be measured. For example, the ink drop height 210 and/or width 212 may be measured with the measurement device 114. As described above, the measurement device 114 may be a laser sensor, camera, or any other suitable device for measuring parameters of the dispensed ink drops. The measured parameters of the ink drops may be used individually or in aggregate (e.g., averaged) to determine the measured parameter and/or size of the dispensed ink drops.

At step 408, the parameters measured in step 406 may be correlated to the firing pulse voltage and/or pulse width they were dispensed with in step 404. In an exemplary embodiment, the measured parameter may be correlated to the firing pulse voltage in a fire pulse database, such as the fire pulse database 300 described above. The fire pulse database 300 may be stored at the measurement controller 116, the system controller 118, or any other appropriate place. After the dispensed ink drop is measured in step 406, the measurement or a representation of the measurement (e.g., a calculated volume based on the measured parameter, a predicted size based on the measured parameter, a relative drop size as described above, etc.) may be stored in the fire pulse database column 306 along with the firing pulse voltage 308 and/or firing pulse width 310. In this way, a table may be built which may be used to determine an appropriate firing pulse voltage and/or firing pulse width required to dispense an ink drop with a predetermined size (e.g., an ink drop with a measured parameter of a particular value). As the size of ink drops for a particular nozzle may vary non-linearly with changes to firing pulse voltage, a look-up table such as fire pulse database 300 may provide a ready correlation between these elements.

Other correlation methods may be used. For example, the firing pulse voltage and the measured parameter may be used to dynamically update an algorithm that approximates the relationship between any of the firing pulse voltage, firing pulse width, and the measured parameter. Such an algorithm may be used alone or in conjunction with a look-up table to determine appropriate firing pulse voltages for instances when an ink drop with a measured parameter that is not on the fire pulse database 300 is desired.

In step 410, an appropriate firing pulse voltage may be selected based on the correlated measured parameter to achieve an ink drop of a predetermined size. By way of example, if an ink drop of a certain size is desired to be dispensed for a particular nozzle (e.g., nozzle 4), that ink drop will have a known value for the measured parameter. Using the fire pulse database 300 the measured parameter may be correlated or looked up (e.g., a measured parameter 306 of D₂). The associated firing pulse voltage 308 (e.g., 73.3V) and/or firing pulse width (4700 ns) may then be determined. This firing pulse voltage and/or width correlation may then be used to dispense the desired size of ink drop from a particular nozzle. The method may pass back to step 404 for further calibration. That is, calibration may be repeated for a particular nozzle and/or performed for other nozzles. The method 400 ends at step 412.

While the foregoing is directed to embodiments of the present invention, other and further embodiments of the invention may be devised without departing from the basic scope thereof, and the scope thereof is determined by the claims that follow.

What is claimed is:

1. A method of calibrating inkjet print nozzles comprising:
dispensing a plurality of ink drops onto a surface with one or more inkjet print nozzles at a firing pulse voltage;
measuring a parameter of the ink drops; and,
calibrating the firing pulse voltage of at least one of the one or more inkjet print nozzles based on the measured parameter of the ink drops.

2. The method of claim 1 wherein calibrating the firing pulse voltage comprises:
correlating the measured parameter of the ink drops with the firing pulse voltage used to dispense the plurality of ink drops; and
selecting a firing pulse voltage based on the correlation so as to cause the inkjet print nozzle to dispense ink drops with substantially the expected value of the measured parameter.

3. The method of claim 2 wherein the selection of the firing pulse voltages is non-linear.

4. The method of claim 2 wherein each of the one or more nozzles select a firing pulse voltage independent of the firing pulse voltages of the other nozzles.

5. The method of claim 1 wherein calibrating the firing pulse voltage comprises calibrating different firing pulse voltages for each of the one or more inkjet print nozzles.

6. The method of claim 1 wherein the plurality of ink drops is dispensed onto substantially flat glass with no black matrix.

7. The method of claim 1 wherein the plurality of ink drops is dispensed into one or more pixel wells.

8. The method of claim 1 wherein the measured parameter is a depth of the ink drops.

9. The method of claim 1 wherein the measured parameter is a width of the ink drop.

10. The method of claim 1 wherein the measured parameter is a volume of the ink drop.

11. The method of claim 1 wherein the parameter is measured using a laser.

12. The method of claim 1 wherein the parameter is measured using a microscope camera.

13. The method of claim 6 wherein the measured parameter is a depth of the ink drop in the pixel wells.

14. A system for calibrating an inkjet print nozzle comprising:
one or more inkjet print nozzles, the inkjet print nozzles adapted to dispense ink drops in response to a firing pulse voltage;
an imaging system adapted to measure a parameter of the dispensed ink drops; and
a controller adapted to correlate the measured parameter of the dispensed ink drops with the firing pulse voltage and pass a signal indicative of the firing pulse voltage to the inkjet print nozzles so as to cause the nozzles to dispense ink drops with substantially the expected value of the measured parameter.

15. The system of claim 14 wherein the imaging system comprises a laser height sensor.

16. The system of claim 14 wherein the imaging system comprises a microscope camera.

17. The system of claim 14 wherein the imaging system comprises a CCD camera.

18. The system of claim 14 further comprising piezoelectric elements within the one or more inkjet print nozzles adapted to generate the firing pulse voltage according to a signal from the controller.

19. An apparatus for calibrating an inkjet printing system comprising:
logic including a processor;
memory coupled to the logic; and
a fire pulse generator circuit coupled to the logic and including a connector to facilitate coupling to a inkjet print nozzle,
wherein the logic is adapted to receive ink drop measurement data, the logic is further adapted to convert the ink drop measurement data to an ink drop measurement data file adapted to be used to trigger the inkjet print nozzle to deposit ink into pixel wells on a substrate with a firing pulse voltage.

20. A method of calibrating inkjet print nozzles comprising:
dispensing a plurality of ink drops onto a surface with one or more inkjet print nozzles at a firing pulse voltage;
determining a size of the ink drops; and,
calibrating a firing parameter of at least one of the one or more inkjet print nozzles based on the size of the ink drops.

21. The method of claim 20 wherein calibrating the firing parameter comprises:
correlating the size of the ink drops with the firing parameter used to dispense the plurality of ink drops; and
selecting a firing parameter based on the correlation so as to cause the inkjet print nozzle to dispense ink drops of a predetermined size.

22. The method of claim 1 wherein the firing parameter is a firing pulse voltage.

23. The method of claim 1 wherein the firing parameter is a firing pulse width.

24. The method of claim 1 wherein the firing parameter is a firing pulse waveform.

25. The method of claim 21 wherein the firing parameter for at least one of the one or more inkjet print nozzles is selected independently of the firing parameters selected for the other nozzles.

26. The method of claim 20 wherein calibrating the firing parameter comprises calibrating different firing parameters for each of the one or more inkjet print nozzles.

27. The method of claim 20 wherein the plurality of ink drops is dispensed onto substantially flat glass with no black matrix.

28. The method of claim 20 wherein the plurality of ink drops is dispensed into one or more pixel wells.

29. The method of claim 20 wherein the size of the ink drops is determined by measuring a depth of the ink drops.

30. The method of claim 20 wherein the size of the ink drops is determined by measuring a width of the ink drops.

31. The method of claim 20 wherein the size of the ink drops is determined by measuring a volume of the ink drops.

32. The method of claim 20 wherein the size of the ink drops is a relative determination compared to other ink drops.
